(19) United States
(12) Patent Application Publication
(10) Pub. No.: US 2017/0320344 A1
(43) Pub. Date: Nov. 9, 2017

(54) PAD HOLDER FOR USE IN AN INSERTION COMPARTMENT FOR A SELF-INKING STAMP

(71) Applicant: COLOP STEMPELERZEUGUNG SKOPEK GESELLSCHAFT M.B.H. & CO. KG., Wels (AT)

(72) Inventor: Ernst FABER, Wels (AT)

(73) Assignee: COLOP STEMPELERZEUGUNG SKOPEK GESELLSCHAFT M.B.H. & CO. KG., Wels (AT)

(21) Appl. No.: 15/585,380

(22) Filed: May 3, 2017

(30) Foreign Application Priority Data
May 4, 2016 (AT) A 50413/2016

(51) Int. Cl. B41K 1/54

(52) U.S. Cl. CPC B41K 1/54

(57) ABSTRACT

A pad holder (1) for use in an insertion compartment (2) of a self-inking stamp with upstroke inking as well as a self-inking stamp having such a pad holder, the pad holder (1) comprising: a bottom (6) and walls (7) projecting from the bottom (6) in a pan-shaped configuration, wherein the bottom (6) and the walls (7) surround a recess (8) for accommodating an ink pad (4), wherein the pad holder (1) has at least one restricting element (9, 10, 28, 29) on an outside, which restricting element (9, 10, 28, 29) is configured for restricting a displacement of the pad holder (1) with respect to the insertion compartment (2) and substantially parallel to the bottom (6) in a maintenance position of the pad holder (1), and wherein in the bottom (6) of the pad holder (1) at least one refill opening (11) is provided, the at least one refill opening (11) being arranged at least partially outside of the insertion compartment (2), in the maintenance position.

The invention relates to a pad holder for use in an insertion compartment of a self-inking stamp with upstroke inking as well as a self-inking stamp having such a pad holder, the pad holder comprising: a bottom and walls projecting from the bottom in a pan-shaped configuration, wherein the bottom and the walls surround a recess for accommodating an ink pad, wherein the pad holder has at least one restricting element on an outside, i.e. facing away from the recess, which restricting element is configured for restricting a displacement of the pad holder with respect to the insertion compartment and substantially parallel to the bottom in a maintenance position of the pad holder. This means that the pad holder may be displaced from a use position located in the insertion compartment to the maintenance position, and the restricting element impedes or prevents a displacement beyond the maintenance position out of the insertion compartment.

The restricting element includes at least one stopper. The restricting element may be formed by a depression or a protrusion, which is configured for restricting a displacement of the pad holder within the insertion compartment of the self-inking stamp. The restricting element may be, for example, part of a retaining device, in which the pad holder, together with an ink pad (or “stamp pad”) accommodated therein, if applicable, may be held in the maintenance position spaced apart from at working position or use position and/or is restrictable in its movement out of the insertion compartment (e.g. in the shape of a slot). The use position refers to the position of the pad holder within the insertion compartment in which the ink pad is arranged for inking a stamp plate, for example in a centred position within the stamp housing.

AT 414 342 B1 discloses a pad holder having at least one latching or stopper element. The latching or stopper element prevents the pad holder from falling out of a slot of a self-inking stamp in an uncontrolled manner. An ink pad accommodated in the pad holder may be re-soaked by suitable ink in an extended replacement position or maintenance position and moved back to a working position or use position again.

EP 0 803 372 A1 shows a self-inking stamp, in which refilling the stamp pad is made possible by nozzles in the bottom of the pad holder after removing the pad holder from the housing or opening a cover of the actuating member. A removable pad support is imperative here since it is intended to facilitate the replacement of the ink pad with respect to the prior art. Accordingly, no restricting element whatsoever is provided for restricting a displacement of the pad holder with respect to the insertion compartment of the housing and substantially parallel to the bottom in a maintenance position of the pad holder. Instead, the pad holder is removable from the housing freely and without any restriction, or it is locked completely in an operating position within the housing by vertical skirt portions of the housing and not displaceable with respect to the insertion compartment.

An object of the invention is to facilitate refilling the ink pad.

According to the invention, this object is achieved by providing at least one refill opening in the bottom of the pad holder, the at least one refill opening being arranged at least partially outside of the insertion compartment, in the maintenance position.

Due to its arrangement, the refill opening is accessible, in the maintenance position, from outside of a stamp housing for refilling the ink pad by ink. In this way, an ink pad accommodated in the recess of the pad holder may be filled or soaked by new stamp ink via the refill opening in the bottom of the pad holder. In an upright position of a self-inking stamp, the bottom of the pad holder is located above the ink pad. Due to the refill opening, the ink pad may be refilled in this upright position. As a consequence, turning both the stamp and the pad holder upside down or removing the pad holder from the stamp is not required for refilling. This means that the stamp assembly having the pad holder may be held, for example, at an easily grippable actuating portion of the stamp during refill, and touching the pad holder itself during refill is not required.

In this context, it has proven particularly advantageous for the at least one refill opening to be surrounded by a nozzle. In case of multiple refill openings each refill opening is preferably surrounded by a respective nozzle associated thereto. Each refill opening is connected to: the (respective) nozzle, for example by the nozzle defining a container opening out into the refill opening. In particular, the nozzle may be formed as a short piece of pipe. Preferably, the nozzle protrudes to the outside from a bottom plane. The nozzle has the advantage that in this way a reservoir is provided for receiving ink while the ink seeps into the ink pad. This means that ink may be supplied faster than it can be received in the ink pad, with the ink supplied being temporarily stored in the nozzle. As a consequence, the user does not have to continually supply ink during the possibly lengthy seeping process, but can fill the nozzle with a larger amount of ink in a short period of time and then do other work. Preferably, the dimensions of the nozzle are chosen such that the volume defined by the nozzle is lower than or equal to the maximum receivable volume of ink in an ink pad.

Furthermore, it is favourable for the walls of the pad holder to be formed by a frame which is designed as a one-piece component and surrounds the recess (encasing an ink pad accommodated therein, if applicable), and for the bottom of the pad holder to be formed by a push-in element fitted into the frame. Here, the frame preferably serves as a sliding surface If the pad holder is displaced within the insertion compartment of the stamp.

In this conjunction, it is advantageous for the frame to include a circumferential undercut on the inside in the region of an opening side of the pad holder opposite to the bottom. Due to the separate manufacturing of the frame and the push-in element, both parts may be manufactured in an injection-moulding process using simple injection-moulding tools despite the undercut. The undercut serves as a holder for an ink pad accommodated in the recess of the pad holder (i.e. the ink pad is held within the frame between the bottom and the undercut) and, at the same time, reduces a sideways discharge of ink, which may accumulate between the ink pad and the frame.

Here it is particularly favourable for the push-in element to be fitted into the frame by means of latching connections. For example, there may be provided two latching lugs on each longitudinal side of the push-in element and corresponding recesses on the inside of the frame. The latching connection provides a reliable and at the same time simple connection that may be established without additional materials (such as adhesives or the like). For sealing the pad holder to prevent a discharge of ink, it is favourable for the push-in element on its part, to have a plate including the at least one refill opening and walls projecting from the plate in a pan-shaped configuration, wherein the walls of the push-in element rest tightly against the walls of the pad holder. In this way, a discharge of ink between the frame and the push-in element is prevented. This is particularly applicable during the inking of a stamp plate of a self-inking stamp when the stamp plate applies pressure onto the ink pad in order to: induce a discharge of ink—though on the side of the stamp plate.

Preferably, the at least one restricting element of the pad holder may be formed by a protrusion on an opening side of the pad holder opposite the bottom. In particular, the restricting element may be formed in the region of an edge of a wall facing away from the bottom. For example, the restricting element(s) may be formed by one or two hill-shaped projection(s) of a longitudinal wall of the pad holder, in particular the frame and/or the push-in element.

Alternatively, however, the restricting element may also be formed by a lateral protrusion or a lateral depression on a front face of the pad holder.

Furthermore, at least one additional restricting element may be provided on a bottom side of the pad holder opposite the opening side, preferably at a location substantially opposite the restricting element arranged on the opening side. In case of multiple restricting elements on both sides, the restricting elements may be arranged in pairs at respective opposite locations. Together, the restricting elements may provide a permanent lock or detent of the pad holder in the insertion compartment such that the pad holder is displaceable within the insertion compartment, but not removable from the insertion compartment. Removing the pad holder is typically used for replacing the pad holder by a new pad holder including a filled ink pad. Due to the simplified refilling, removing is no longer required. The permanent lock or blockage of the pad holder within the stamp prevents accidental falling out as well as loss of the pad holder in a reliable way.

If all of the restricting elements are arranged in the region of only one longitudinal side of the pad holder, the pad holder is substantially fully displaceable out of the insertion compartment in the direction of the other longitudinal side, thus providing ideal accessibility to the bottom of the pad holder and the refill openings provided therein. In this way, refill openings may be provided at virtually any location of the bottom, so their arrangement may be directed toward an ideal soaking of the ink pad.

For the initial insertion of the pad holder into a self-inking stamp, i.e. into its insertion compartment, it is useful for at least one of the restricting elements to have a chamfer at an outer longitudinal edge. The chamfer facilitates passing a restricting element in one direction. In the opposite direction, the blockage of the pad holder is not compromised by this. Accordingly, the claimed chamfer facilitates pushing the pad holder into the insertion compartment while it does not facilitate removing the pad holder. In particular, each of the restricting elements on one side of the pad holder may include a respective chamfer.

Moreover, it is favourable for the pad holder to have at least one latching element on the outside, which latching element is configured for holding the pad holder in the insertion compartment in a use position of the pad holder. The fixation in a centred use position obtainable by the latching element allows a reliable orientation of the ink pad with respect to the stamp plate prior to the inking. A shifting of the ink pad, which may lead to an only partial contact between the stamp plate and the ink pad, may be prevented by an appropriate fixation.

In particular, the present invention also relates to a self-inking stamp, comprising: a stamp housing, an actuating member, a stamp unit, and an ink pad, wherein the stamp unit is supported rotatably and displaceably within the stamp housing, wherein the actuating member is coupled to the stamp unit supported within the stamp housing and is displaceable, together with the stamp unit and with, respect to the stamp housing, between an inking position, in which the stamp unit contacts the ink pad, and a stamping position, in which the stamp unit protrudes from the stamp housing in the direction of a stamping side, and wherein the ink pad is accommodated in a pad holder according to the types discussed above, which pad holder is supported displaceably within an insertion compartment of the stamp housing.

The invention is explained in further detail below on the basis of particularly preferred exemplary embodiments, but without being limited to them, and with reference to the drawings. Individually, in the drawings:

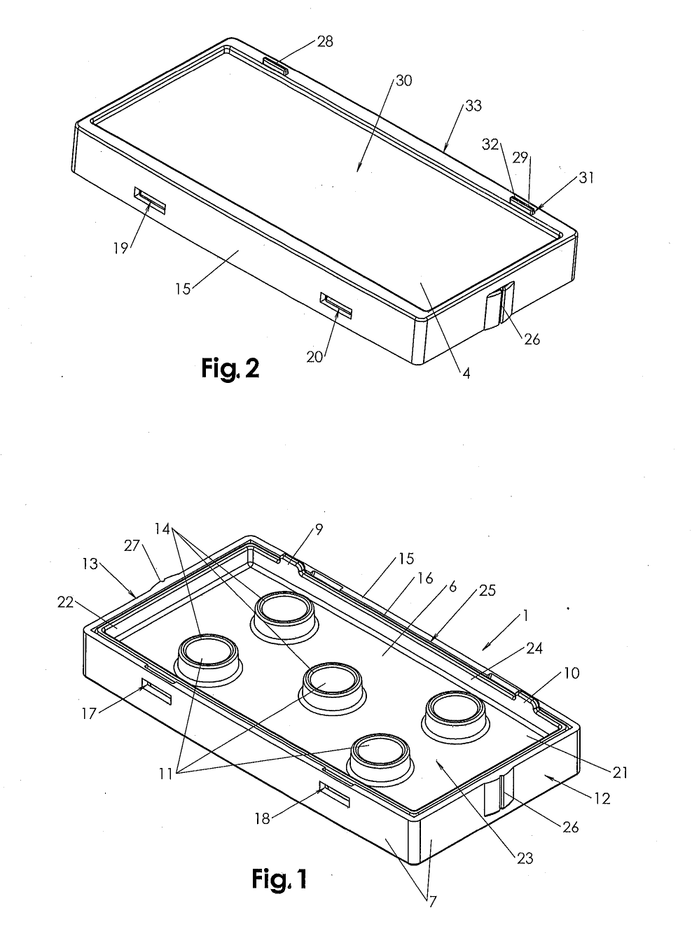

FIG. 1 shows a schematic view of a bottom side of a pad holder according to the invention;

FIG. 2 shows a schematic view of an opening side of the pad holder of FIG. 1;

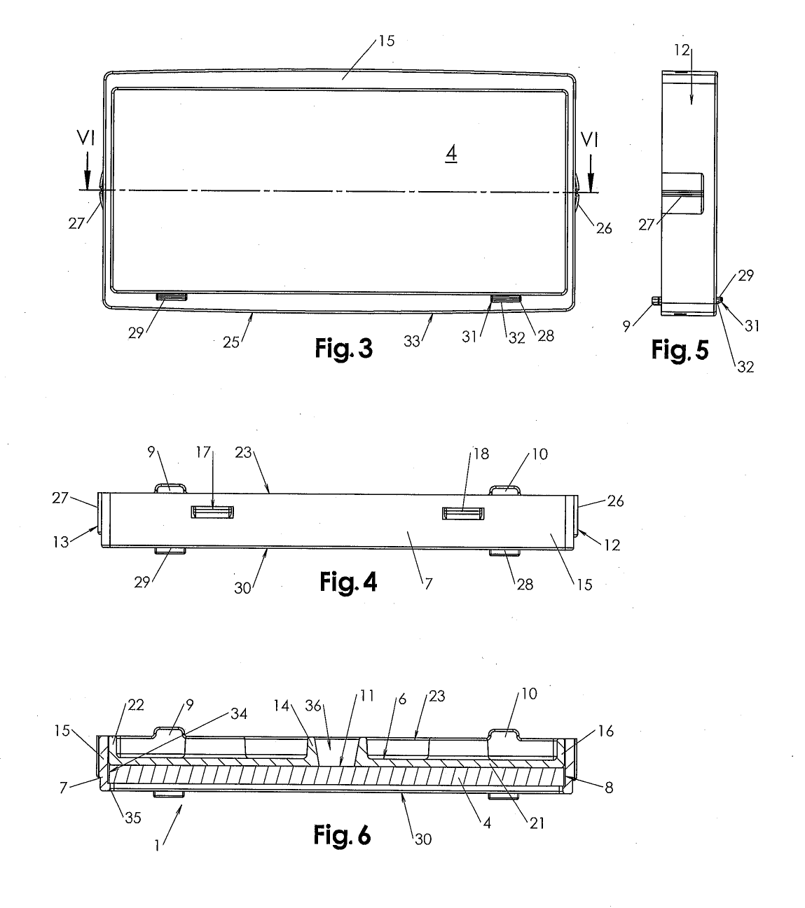

FIG. 3 shows a plan view of the opening side of the pad holder of FIG. 1;

FIG. 4 shows a side view of a longitudinal side of the pad holder of FIG. 1;

FIG. 5 shows a side view of a front face of the pad holder of FIG. 1;

FIG. 6 shows a sectional view of the pad holder according to FIG. 1 along line VI-VI in FIG. 3; and

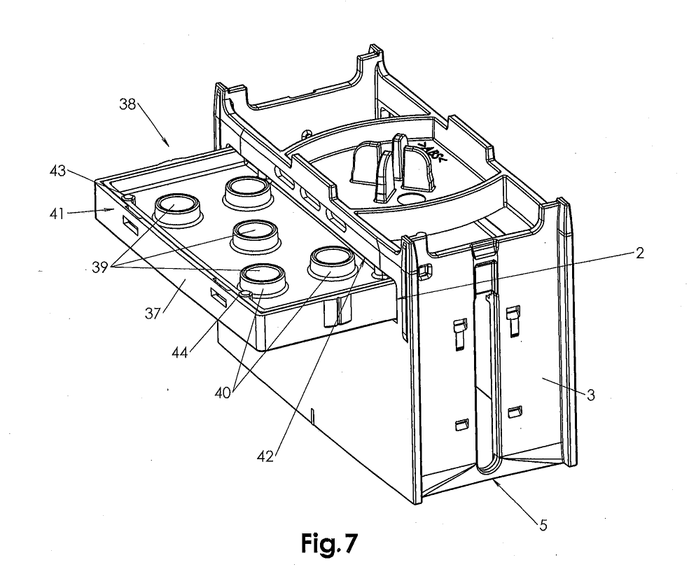

FIG. 7 shows a schematic view of a stamp housing of a self-inking stamp having a pad holder arranged in a maintenance position therein.

FIG. 1 shows a pad holder 1 for use in an insertion compartment 2 (cf. FIG. 7) of a self-inking stamp with upstroke inking. Such stamps are widely known, for example from EP 1 603 7 54 B1, FIGS. 1-3 of which show exemplary embodiments of such a stamp. In general, a self-inking stamp with upstroke inking includes a stamp housing 3 (cf. FIG. 7), an actuating member, a stamp unit, and an ink pad 4 (cf. FIG. 6). The stamp unit is supported rotatably and displaceably within the stamp housing 3. The actuating member is coupled to the stamp unit supported within the stamp housing 3. Together with the stamp unit, it is displaceable with respect to the stamp housing 3 between an inking position, in which the stamp unit contacts the ink pad 4, and a stamping position, in which the stamp unit protrudes from the stamp housing 3 in the direction of a stamping side 5. Under control of the actuating member, the stamp unit may be turned inside the stamp housing 3, mostly by 180°, from the upper inking position to the lower stamping positions by a turning mechanism. This turning mechanism is also summarised by the term “up-stroke inking”. In the upper inking position, the idle position of the hand stamp, the stamping plate provided with stamp types (the printing block) rests against the ink pad 4. Here, the ink pad 4 is accommodated within a special container called a pad holder 1. The ink pad 4 or rather the pad holder 1 including the ink pad 4 may be displaced horizontally within an accommodation space or an insertion compartment 2 in the stamp housing 3, which is usually designed in the form of a slot, for example in order to soak the ink pad 4 by fresh stamp ink outside of the stamp housing 3.

The pad holder 1 illustrated in FIG. 1 comprises a bottom 6 and walls 7 projecting from the bottom in a pan-shaped configuration. The bottom 6 and the walls 7 surround a recess 8 (cf. FIG. 6) for accommodating an ink pad 4. On an outside, the pad holder 1 includes two restricting elements 9, 10. The restricting elements 9, 10 are configured for restricting a displacement of the pad holder 1 with respect to the insertion compartment 2 and substantially parallel to the bottom in a maintenance position of the pad holder 1. In the bottom 6 of the pad holder 1, five refill openings 11 are provided. In the maintenance position (cf. 38 in FIG. 7), the refill openings 11 are arranged at least partially outside of the insertion compartment 2. In the illustrated example, the refill openings 11 are arranged offset with respect to the restricting elements 9, 10 in the direction of displacement (i.e. parallel to the front faces 12, 13 of the pad holder 1). Each of the five refill openings 11 is surrounded by a respective associated nozzle 14.

The walls 7 of the pad holder 1 are formed by a frame 15. The frame 15 is designed and manufactured as a one-piece component, for example by an injection-moulding process, and surrounds the recess 8 for accommodating an ink pad 4. The bottom 6 of the pad holder 1 is formed by a push-in element 16 fitted into the frame 15. The push-in element 16 is fitted into the frame 15 by latching connections 17, 18, 19, 20. The push-in element 16 on its part includes a plate 21 and walls 22 projecting from the plate 21 in a pan-shaped configuration. The five refill openings 11 are provided in the plate 21. The walls 22 of the push-in element 16 rest tightly against the walls 7 of the pad holder 1 (cf. FIG. 6).

On the bottom side 23 of the pad holder 1 seen in FIG. 1, two restricting elements 9, 10 are provided. The two restricting elements 9, 10 are formed as hills continuing a longitudinal wall 24 of the push-in element 17 in a direction away from the plate 21 and projecting substantially vertically from the bottom side 23. As can further be seen in FIG. 1, restricting elements 9, 10 are arranged only in the region of one (i.e. exactly one) of the longitudinal sides 25 of the pad holder 1.

On the outside, the pad holder 1 includes two latching elements 26, 27, with one respective latching element 26, 27 arranged centred on each of the two front faces 12, 13 of the pad holder 1. The latching elements 26, 27 are configured for holding the pad holder 1 in the insertion compartment 2 in a use position of the pad holder 1.

The two restricting elements 28, 23 seen in FIG. 2 are protrusions formed on the frame 15, on an opening side 30 of the pad holder 1 opposite the bottom 6. These restricting elements 28, 29 are arranged offset to the inside from the outer edge of the pad holder 1, as can best be seen in FIG. 3. Individually, they are arranged at locations on the opening side 30 substantially opposite the restricting elements 9, 10 arranged on the bottom side 23, as can best be seen in the side views in FIG. 4 and FIG. 5.

The two restricting elements 28, 29 provided on the opening side 30 of the pad holder 1 include a chamfer 32 on an outer longitudinal edge 31 (cf. also FIG. 3). This means that the side face of the restricting elements 28, 29 closer to an outer edge 33 of the pad holder 1 is bevelled such that the cross-sections of the restricting elements 28, 29 narrow towards their upper ends.

The sectional view illustrated in FIG. 6 makes clear that, in the region of an opening side 30 of the pad holder 1 opposite the bottom 6, the frame 15 has a circumferential undercut 35 on the inside 34. In the region of the lateral edges, the ink pad 4 is thus held between the undercut 35 and the plate 21 of the push-in element 16. Furthermore, FIG. 6 shows a section through a refill opening 11 arranged in the centre having an associated nozzle 14. Together with the refill opening 11, the nozzle 14 forms a substantially pot-shaped reservoir 36 from which ink can seep into the ink pad 4 positioned therebelow.

FIG. 7 illustrates an alternative pad holder 37 in a maintenance position 38. Here, the major portion of pad holder 37 is displaced out of an insertion compartment 2 of a stamp housing 3 so each of the five refill openings 39 is accessible from outside of the stamp housing 3, and ink may be filled into each of the respective associated nozzles 40 for soaking an ink pad as required. In contrast to the first exemplary embodiment, restricting elements 43, 44 are provided on both longitudinal sides 41, 42 of this pad holder 37. In this case, the respective unused restricting elements 43, 44 (positioned in the maintenance position outside of the stamp housing) need to be passed when moving the pad holder 37 to a use position accommodated within the insertion compartment 2. Thus, the restricting elements 43, 44 can provide only little protection against, the falling out of the pad holder 37 from the stamp housing 3.

1. A pad holder (1) for use in an insertion compartment (2) of a self-inking stamp with upstroke inking, comprising:
a bottom (6), and
walls (7) projecting from the bottom (6) in a pan-shaped configuration,
wherein the bottom (6) and the walls (7) surround a recess (8) for accommodating an ink pad (4),
wherein the pad holder (1) has at least one restricting element (9, 10, 28, 29) on an outside, which restricting element (9, 10, 28, 29) is configured for restricting a displacement of the pad holder (1) with respect to the insertion compartment (2) and substantially parallel to the bottom (6) in a maintenance position of the pad holder (1),
wherein in the bottom (6) of the pad holder (1) at least one refill opening (11) is provided, the at least one refill opening (11) being arranged at least partially outside of the insertion compartment (2), in the maintenance position.

2. The pad holder (1) according to claim 1, wherein the at least one refill opening (11) is surrounded by a nozzle (14).

3. The pad holder (1) according to claim 1, wherein the walls (7) of the pad holder (1) are formed by a frame (15), which is designed as a one-piece component and surrounds the recess (8), and wherein the bottom (6) of the pad holder (1) is formed by a push-in element (16) fitted into the frame (15).

4. The pad holder (1) according to claim 3, wherein the push-in element (16) on its part includes a plate (21) having the at least one refill opening (11) and walls (22) projecting from the plate (21) in a pan-shaped configuration, wherein the walls (22) of the push-in element (16) rest tightly against the walls (7) of the pad holder (1).

5. The pad holder (1) according to claim 1, wherein the at least one restricting element (28, 29) of the pad holder (1) is formed by a protrusion on an opening side (30) of the pad holder (1) opposite the bottom (6).

6. The pad holder (1) according to claim 5, wherein at least one further restricting element (9, 10) is provided on a bottom side (23) of the pad holder (1) opposite the opening side (30), preferably at a location substantially opposite the at least one restricting element (28, 29) arranged on the opening side (30).

7. The pad holder (1) according to claim 5, wherein all of the restricting elements (9, 10, 28, 29) are arranged in the region of only one longitudinal side (25) of the pad holder (1).

8. The pad holder (1) according to claim 5, wherein at least one of the restricting elements (28, 29) includes a chamfer (32) on an outer longitudinal edge (31).

9. The pad holder (1) according to claim 1, wherein the pad holder (1) includes at least one latching element (26, 27) on the outside, which latching element (26, 27) is configured for holding the pad holder (1) in the insertion compartment (2) in a use position of the pad holder (1).

10. A self-inking stamp, comprising:
a stamp housing (3),
an actuating member,
a stamp unit, and
an ink pad (4),
wherein the stamp unit is supported rotatably and displaceably within the stamp housing (3),
wherein the actuating member is coupled to the stamp unit supported within the stamp housing (3) and is displaceable, together with the stamp unit and with respect to the stamp housing (3), between an inking position, in which the stamp unit contacts the ink pad (4), and a stamping position, in which the stamp unit protrudes from the stamp housing (3) in the direction of a stamping side (5),
wherein the ink pad (4) is accommodated in a pad holder (1) according to claim 1, which pad holder (1) is supported displaceably within an insertion compartment (2) of the stamp housing (3).
